(19) United States
(12) Patent Application Publication
(10) Pub. No.: US 2025/0035481 A1
(43) Pub. Date: Jan. 30, 2025

(54) METHOD FOR DETECTING IMPROPER POSITION OF VEHICLE ON A SCALE

(71) Applicant: Mettler-Toledo, LLC, Columbus, OH (US)

(72) Inventors: Eric V. Wechselberger, Powell, OH (US); Jessica Ferree, Columbus, OH (US)

(21) Appl. No.: 18/713,723

(22) PCT Filed: Dec. 13, 2021
(86) PCT No.: PCT/US2021/063074

§ 371 Date: May 28, 2024

(51) Int. Cl. G01G 19/02

(52) U.S. Cl. CPC G01G 19/024

(57) ABSTRACT

A method detects improper positioning of a vehicle on a weight scale, especially improper transverse positioning. A weight scale for weighing a multi-axle vehicle has a weighing platform, with a weighing area having a length and a width, for simultaneous placement of the plurality of axles on the weight platform. A portion of the weight of the multi-axle vehicle is sensed in at least one load cell upon which the weighing platform bears. A resulting output signal from each load cell is transmitted. An at least partial vehicle weight waveform of vehicle weight as a function of time, based on the at least one load cell output signal is generated. A weighment of the vehicle is rejected if the generated vehicle weight waveform indicates that at least some portion of the vehicle was improperly positioned outside the weighing area.

### TECHNICAL FIELD

The disclosed invention relates to a method for assuring that a vehicle passing over a scale is properly weighed. If the vehicle is not properly positioned during the weighing process, an inaccurate weight results. Three methods are presented for detecting improper position of a vehicle on a scale.

### BACKGROUND ART

As used in the application, a “weighment” refers to the act or process of determining a weight, for example, a weight that is accepted under regulatory standards for use in a commercial transaction. Weighment for vehicle scales occurs during the time a vehicle enters a scale until the vehicle exits the scale or a final weight is determined. A weight is the culmination of a weighment and the singular value determined as the vehicle's gross weight.

Vehicle scales are a ubiquitous part of the commercial landscape when goods are transported by truck. There are at least two primary reasons why it is important to be able to weigh a vehicle and its contents.

A first reason is the need to determine the net weight of goods loaded in the vehicle. By weighing a vehicle while empty and then while loaded, a net weight of the goods loaded onto the vehicle can be determined. This can be used, for example, at a grain elevator when a truckload of wheat is loaded to be transferred to a mill. Similarly, weighing the truck at the mill before and after discharging the wheat into the mill's storage system. While this example involves agricultural goods, it is equally applicable to a large variety of bulk goods, including waste, aggregates, and chemicals.

A second reason is the need to be able to determine or verify the gross weight of a vehicle. Such a weighment may be required by a government agency, as in verifying that the vehicle is within a prescribed limit for road limit enforcement, or it may be required by a private entity for a purpose such as inventory control. Compliance with legal load limits prevents damage to roads and bridges due to overweight vehicles. An actual gross weight may also be compared to an expected gross weight based on the cargo manifest as a quality check or fraud prevention.

For at least these purposes, an accurate weight is important to all of the stakeholders. The vehicles of interest have a plurality of axles arranged along a length of the vehicle, each axle having at least one wheel at each end. Some of the axles may be arranged in assemblies having two or more axles, and some of the axles may have two or more wheels at each end. An accurate weight requires each wheel of the vehicle to be fully on the weighing platform during the weighment, preferably with the vehicle centered on the weighing platform.

### SUMMARY

These and other objectives are achieved by a method for detecting an improper positioning of a vehicle on a weight scale.

A first step of the method involves providing a weight scale for weighing a multi-axle vehicle. The weight scale has a weighing platform, with a weighing area having a length and a width, for simultaneous placement of the plurality of axles on the weight platform.

A second step of the method involves sensing a portion of a weight of the multi-axle vehicle in at least one load cell upon which the weighing platform bears, and transmitting an output signal from each load cell.

A third step involves generating an at least partial vehicle weight waveform of vehicle weight as a function of time, based on the at least one load cell output signal.

A fourth step involves determining whether to reject a weighment of the vehicle, if the generated vehicle weight waveform indicates that at least some portion of the vehicle was improperly positioned outside the weighing area.

In some embodiments of the method, the vehicle weight waveform is a static measurement generated by stopping the vehicle on the weighing platform.

In other embodiments, the vehicle weight waveform is a dynamic measurement generated by driving the vehicle across the weighing platform without stopping.

In many of the embodiments, the vehicle weight waveform generated has a first portion that increases monotonically as the vehicle enters the weighing platform and has a second portion that decreases in a symmetrically inverse manner as the vehicle exits the weighing platform, such that, in determining proper positioning, an unexpected decrease during the first portion or an unexpected increase during the second portion indicates an improper positioning of the vehicle on the weighing platform.

In these methods, the first portion of the vehicle weight waveform comprises a series of plateaus that correspond to the number of axles or axle groups in the multi-axle vehicle.

In these methods, an absence of inverse symmetry between the first and second portions of the vehicle weight waveform indicates improper positioning of the vehicle.

In some of the methods, the weight scale has means for generating weight signal noise provided on a surface laterally adjacent to the weighing platform. In some of these embodiments, the weight signal noise generating means can comprise raised bumps. In other embodiments, the weight signal noise generating means can comprise grooves cut into the lateral surface. In any of these embodiments, the weight signal noise generating means may be spaced at regular intervals.

In the embodiments involving the weight signal noise generating means, the presence of weight variations in any portion of the vehicle weight waveform plateaus indicates improper lateral positioning of the vehicle.

In some of the embodiments, the steps of generating and analyzing the vehicle weight waveform to determine if the vehicle is improperly positioned are conducted by an algorithm operable in a hardware processing system, particularly one that is associated with the weight scale

If the weighment is not rejected in the fourth step, then the vehicle weight is determined from the vehicle weight waveform.

### BRIEF DESCRIPTION OF THE DRAWINGS

A better understanding of the inventive concept will be had when reference is made to the accompanying drawings, wherein identical parts are identified with identical reference numbers and wherein:

FIG. 1 is a perspective view of a typical above-grade vehicle weigh scale;

FIG. 2 is a graph of a weight v. time waveform generated by a five-axle tractor trailer vehicle driving in proper lateral position across the vehicle weigh scale;

FIG. 3 is a graph of a weight v. time waveform generated by the five-axle tractor trailer vehicle driving in an improper lateral position across the vehicle weight scale;

FIG. 4 is a perspective view of a typical at grade vehicle weigh scale with additional weight signal noise generating means installed laterally adjacent to the weighing platform;

FIG. 5 is a graph of a weight v. time waveform, depicting the effect of using a means for intentionally generating signal noise adjacent to the edges of the vehicle weigh scale to detect improper lateral position of a vehicle; and

FIG. 6 is a magnified view of a portion of the FIG. 5 waveform, depicting the effect of using means for intentionally generating signal noise adjacent to the edges of the vehicle weigh scale during one of the waveform plateaus.

### DETAILED DESCRIPTION OF THE INVENTIVE CONCEPT

During a weighing operation, a vehicle being weighed may be improperly positioned on the vehicle scale, that is, with one or more wheels not bearing its portion of the vehicle weight onto the scale. Regardless of the intent, the improper position of the vehicle causes the weight registered by the vehicle scale to be lower than the actual or true weight of the vehicle. This will result in an erroneous commercial transaction, or an erroneous decision regarding road limit enforcement or inventory control. Any weight determined while a vehicle is improperly positioned on the weighing platform must be rejected until the vehicle can be repositioned properly.

In one common situation, referred to as a longitudinal vehicle mispositioning error, one or more wheels, usually on either the frontmost axle or the rearmost axle, may be located beyond a longitudinal extent of the vehicle scale. This is due to the vehicle being pulled too far forward or not far forward enough. In such a case, a full axle is not being registered.

In another common situation, referred to as a transverse vehicle mispositioning error, one or more wheels, on either the left side or right side of the vehicle, may be located off a transverse extent of the vehicle scale because the vehicle has pulled too far to one side. And, of course, there can be a combination of both types of improper positioning.

Improper vehicle positioning is not a new problem, but the issue may have become more prevalent. A traditional vehicle weighing operation, at a commercial installation or at a roadside weigh station, employs a scale operator whose responsibilities include ensuring the vehicle is properly positioned on the weighing platform during the weighment. The scale operator may be located in a scale house positioned to one side of the weighing platform, possibly at some distance from the scale entry/exit points. From this vantage point, it may be difficult for the scale operator to determine whether the vehicle is properly positioned on the weighing platform. Generally, the view of the perimeter of the weighing platform will be partially obstructed by the vehicle itself. The routine and monotonous nature of the weighing operation can lead to careless attention by the scale operator. An unscrupulous scale operator may even intentionally ignore a vehicle mispositioning error in a coordinated fraud with the vehicle operator.

The trend in recent years has been to increase the workload of scale operators or even to not have a scale operator present at the site. In these unattended applications the scale owner relies on the ability and honesty of the vehicle operator to properly position the vehicle on the weighing platform.

When a vehicle scale is installed at grade such that the weighing platform is flush with the surrounding roadbed over which the vehicle moves to enter and exit, the scale is susceptible to both types of vehicle mispositioning errors. The vehicle operator must judge the position of the vehicle's wheels relative to the perimeter of the weighing platform with little guidance. This can be especially difficult if the entire area is covered by snow. Sometimes barriers, curbs, or bollards are used to provide the vehicle operators some guidance for transverse positioning. These are unappealing to scale owners as they are expensive to install and to vehicle operators as they may cause damage to their vehicle.

When a vehicle scale is installed above grade, ascending and descending ramps are required for the vehicle to reach the weighing platform. Often, these scales will have guard rails installed along the sides for safety. The guard rails prevent vehicle transverse mispositioning errors off the lateral side edges of the weighing platform. However above grade vehicle scales are still susceptible to vehicle longitudinal mispositioning errors.

Vehicle scales used in commercial transactions are subject to certification and inspection by a Weights & Measures (W&M) authority to assure equity in the marketplace. Because of the need for regularity, national and international organizations have established standards that designate how a vehicle scale is allowed to operate. These standards require a vehicle to be weighed statically in a single draft (i.e. entire vehicle is weighed simultaneously while stopped on the scale).

Vehicle scales that are not used in commercial transactions (e.g. for enforcement or inventory control) are not required to be certified and inspected by a Weights & Measures authority. As a result there is more flexibility in how the vehicle scale may operate. In this case a vehicle may still be weighed statically in a single draft, or may be weighed dynamically in a single draft without stopping on the scale.

In all cases mentioned above (commercial transactions, enforcement and inventory control) it is important for a vehicle to be properly positioned to obtain the most accurate weight possible. This invention provides multiple methods to automatically detect a mispositioned vehicle on single draft scale.

Solutions that exist today to automatically determine if a vehicle is properly positioned on a weighing platform require sensors to be located around the perimeter of the weighing platform. These sensors may consist of optical beams or pressure sensitive pads, and add cost to the scale. Sensors at the entry and exit edge of the weighing platform can be used to count the number of axles that pass over each end to detect longitudinal mispositioning errors. Additional sensors at the side edges of the weighing platform can be used to detect transverse mispositioning errors. Since these sensors are located near the surface of the weighing platform they may be subject to damage by vehicles (e.g. trucks, snow plows, etc.) running over them, and may become unreliable due to dirt accumulation and weather conditions (e.g. rain, snow, ice, etc.).

The inventive concept pertains to methods for automatically detecting improper positioning of a vehicle on a weighing platform using the scale's weight output while the vehicle drives onto the scale from one end, one axle at a time, and exits from the other end, one axle at a time. The improper positioning may be caused by vehicle longitudinal mispositioning errors, transverse mispositioning errors, or both. These methods can be automated and eliminate the human factors related to detecting improper vehicle positioning on a weighing platform. Barriers, curbs, bollards, or guard rails along the side edges of a scale weighing platform are not required. By using the scale's weight output, no additional sensors are required. This reduces the cost and improves the reliability compared with other current solutions.

### Method for Detecting Longitudinal Vehicle Mispositioning on a Static Single Draft Scale Using Peak Level Comparison:

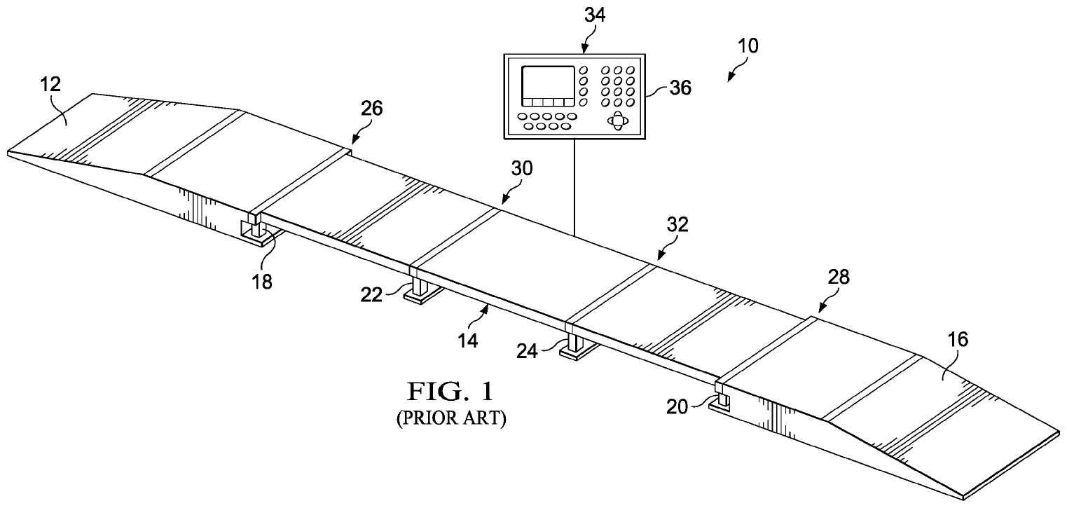

As disclosed in the applicant's co-pending US patent application, published as US 2021/0231486, FIG. 1 illustrates an embodiment of a vehicle weight scale that can be used to determine the total weight of a vehicle, either statically or dynamically, using the sensed weight from the plurality of load cells. To be useful, the weight scale 10 has sufficient length so that each of a plurality of axle sets of the vehicle can be located on the weight scale simultaneously. The weight of the vehicle on the scale can be determined from the plurality of weight sensors (e.g., load cells) and be plotted as a function of time as the vehicle enters and exits the weight scale. A difference between a static and a dynamic measurement of the vehicle in such a plot is the elongation of the time dimension by the length of time when the vehicle is stopped on the weight scale 10 during the static weighing.

The weight scale 10 depicted in FIG. 1 is shown as being located above grade, so the vehicle enters a first ramp 12, moves onto a weighing platform 14 that is sized and adapted to receive the entire vehicle, and then rolls off the weight scale on a second ramp 16. If the weighing platform 14 happens to be positioned at grade, the ramps 12, 16 are not needed and the weighing platform is positioned above a pit that accommodates the weight sensors, which are shown as load cells. On a near side of the weight scale 10, the weight sensors are a first load cell 18 at a first end of the weighing platform 14, a second load cell 20 at a second end, with a third load cell 22 and a fourth load cell 24 located between the first and second load cells. Common practice would be to mirror the placement of load cells 18, 20, 22 and 24 on a far side of the weighing platform 14 at locations 26, 28, 30 and 32. This is one embodiment. Other embodiments may have less or more load cells depending on the scale length, number of platforms, multi or single deck platforms, etc. The load cells, which can be digital or analog, are in communication with a hardware processing system 36 that obtains the weight readings, processes the data, and electronically sends weight and other information to a display 34. In some embodiments, such as the one depicted in FIG. 1, the hardware processing system 36 is a processor located in the same housing as the display 34. The hardware processing system 36 is programmed with instructions when executed configure the processor to either: 1) obtain a weight of a vehicle statically if all of the axle sets of the vehicle are located on the weighing platform 14 simultaneously and the vehicle is in a stopped condition; or 2) obtain the vehicle weight dynamically if all of the axle sets of the vehicle are located on the weighing platform 14 simultaneously and the vehicle is moving on the weight scale 10. This is achieved by analyzing a waveform of the vehicle weight signal as a function of time.

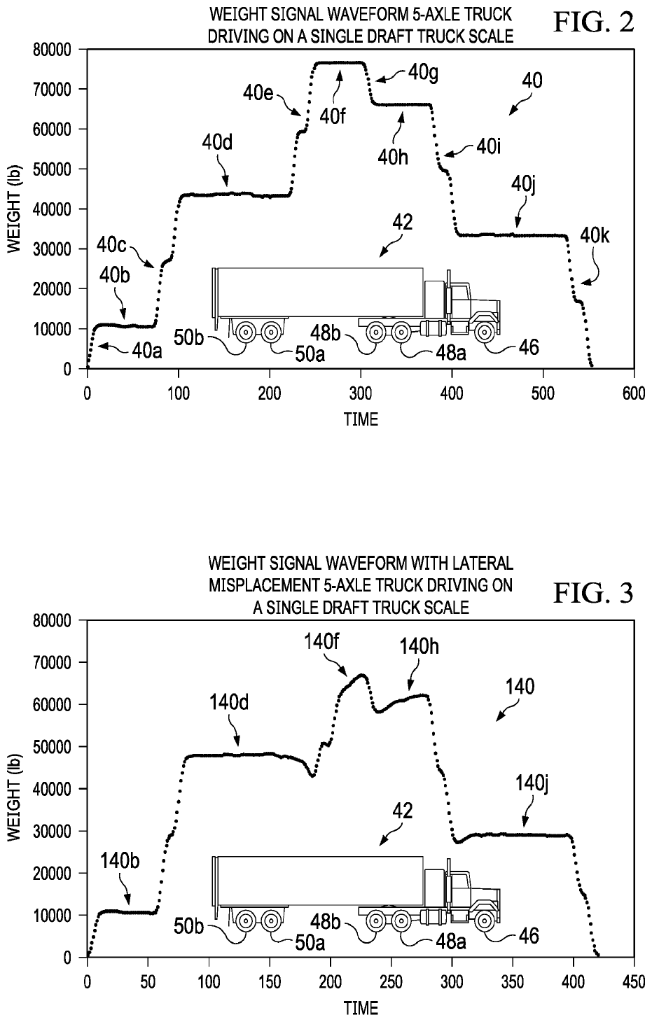

FIG. 2 provides an example of such a weight signal waveform 40, based on a proper dynamic weighing of a 5-axle truck on the weight scale. For convenience, FIG. 2 also shows an exemplary illustration of such a 5-axle truck 42 of the type that would create the waveform 40. Truck 42 has its 5 axles provided at three locations: a single front axle 46 is located at a front end of a tractor portion. A pair of axles 48a, 48b are located at a rear end of the tractor portion, essentially beneath a “fifth wheel” that connects a trailer to the tractor. A final pair of axles 50a, 50b are located near a rear end of the trailer. The waveform 40 illustrates how weight is loaded onto, and removed from, the weighing platform 14 as a function of time. In a first portion 40a, with a large positive slope, the weight borne by the front axle 46 is received on the weighing platform 14, followed by a second portion 40b, a generally flat plateau, in which the wheels of axle 46 bears solely on the scale. A third portion 40c of the waveform 40 has a strong positive slope, with an intermediate inflection, showing the weight of axles 48a and 48b joining the weight of front axle 46, with the inflection showing the linear spacing between axle 48a and axle 48b. The total weight of axles 46, 48a and 48b provide the output in fourth portion 40d, a plateau similar to second portion 40b. The horizontal length of this plateau reflects the length of time before axles 50a, 50b encounter the weight scale. As axles 50a, 50b enter the platform 14, the fifth portion 40e has a strong positive slope with an inflection point, reflecting the entry of these axles, analogously to third portion 40c. At this point, the entire weight of the truck 42 is on the platform 14, providing sixth portion 40f, another plateau, but at a higher weight than the prior plateau. For static weighing, the truck should stop at this time, with the waveform 40 increasing in a stepwise fashion to a maximum level and an elongation of the time dimension by the length of time when the vehicle is stopped. It may be assumed that a proper weighment has occurred, and the truck may leave the weigh scale 10.

If there has been a proper weighment, the remainder of the waveform 40 generated as the truck 42 exits the platform 14 is inversely symmetrical to the waveform generated while the vehicle was entering the scale. Specifically, the seventh waveform portion 40g shows a downward slope that reflects the exit of axle 46 from the platform 14. An eighth portion 40h of the waveform that follows should be a plateau. If the plateau of the second portion 40b indicates a weight of X pounds, the plateau of the fourth portion 40d indicates a weight of Y pounds and the sixth portion 40f indicates a weight of Z pounds, then the eighth portion 40h should indicate a weight that is substantially equal to (Z-X) pounds. As the intermediate axles 48a, 48b exit the scale, in a downwardly sloping manner with an intermediate inflection point, the waveform 40 has a ninth portion 40i and moves to a further plateau portion 40j, at a weight substantially equal to (Z-Y) pounds. Portion 40j indicates that the only axles remaining on the platform 14 are axles 50a, 50b. Finally, as these axles leave the platform 14, there is a final downwardly sloping portion 40k, with an inflection point showing the separation between the two axles. The waveform 40 at this point has returned to the base weight level, indicating no vehicle is on the platform 14. If the waveform 40 does not exhibit this inverse symmetry of substantially equivalent weights as the vehicle leaves the platform 14, there is an issue that bears attention.

It should be kept in mind that the full waveform 40 only becomes available once the vehicle has cleared the platform 14. It should also be kept in mind that the waveform 40 of FIG. 2 depicts an ideal situation, where a proper weighment occurred. However, if the vehicle has pulled too far forward before stopping, the plateau at position 40f will show a weight decrease after reaching the maximum plateau, indicating the first axle 46 has started to come off the scale before the vehicle has stopped for the static weight determination. This is the most common form of a longitudinal mispositioning error. The driver can be given a notification and needs to reposition their vehicle to complete a weighment.

The weight signal waveform 40 can also be used to determine if a vehicle has not pulled far enough forward. In that case, the plateau at position 40f will show a weight increase after the vehicle has stopped and has started to leave the platform 14. This increase indicates an additional axle started to come onto the scale after the point the vehicle stopped for a weight determination. The driver will receive a notification the weighment is invalid and need to reweigh.

### Method for Detecting Transverse Vehicle Mispositioning on a Static or Dynamic Single Draft Scale Using the Plateaus of the Weight Signal Waveform.

As described above with regard to FIG. 2, when a vehicle, such as five-axle truck 42, drives onto a scale 10, the weight on the scale increases in a stepwise fashion as each of the vehicle's axles comes onto the scale. When all the vehicle's axles are on the scale, the weight reaches a maximum level. As the vehicle drives off the scale, the weight decreases in a stepwise fashion, as each of the vehicle's axles come off the scale. These weight changes, as a function of time, create an inversely symmetrical weight signal waveform consisting of multiple distinct plateaus. The number of plateaus corresponds to the number of axle groups on the vehicle. The width of the plateaus in time corresponds to the spacing between the axles and speed of the vehicle.

It has been observed that the shape of a weight signal waveform can be used to monitor if a vehicle has driven off the lateral side edges of the scale during the weighment. FIG. 2 shows and describes an ideal situation involving a 5-axle vehicle having the axles distributed in three groups: one single axle group and two groups of two axles. If such a vehicle 42 is driven so that at least some of the wheels are displaced laterally off of the weighing platform, a waveform 140 as shown in FIG. 3 may result. The waveform 140 is very asymmetric. Unexpected increases and decreases of the displayed weight are seen. In particular, the weight portrayed in the ideal waveform 40 of FIG. 2 is characteristically monotonic, increasing in a first half of the waveform and decreasing in a second half. However, and especially in the plateaus, the monotonicity in waveform 140 is disrupted. Attention is directed to the plateau portions 140b, 140d, 140f, 140h and 140j. In portion 140b, it appears that the first axle 46 is properly aligned. Similarly, portion 140d seems to show that the intermediate axles 48a, 48b are also aligned, but the latest (right-most) section of portion 140d suggests that at least some portion of axles 46, 48a or 48b are at least partially off of the platform 14. Portion 140f is so severely disfigured that it is significantly confounded with portion 140h, to the extent that they are difficult to distinguish from each other. There is a general recovery of the flat plateau shape in portion 140j. In this case the driver will receive a notification and need to reweigh in the proper position to complete the weighment.

Manual review of the waveform 140 can provide the basis to issue a notification. Storage of the recorded waveform 140 in a memory portion of the hardware processing system 36 can be used to demonstrate the problem to the driver. Specifically, if there is any significant weight decrease in the waveform 140 while the waveform is still in its increasing phase, the decrease indicates that weight that was previously on the platform 14 has come off of the platform. Similarly, if the indicated weight increases while the waveform 140 is in the decreasing phase, this shows that weight that was off of the platform 14 has come onto the platform. Further, implementation of a machine learning module, or another coding algorithm, into the hardware processing system 36 permits improper positioning of a vehicle to be automatically detected and flagged.

### Method to Detect Transverse Vehicle Mispositioning on a Static or Dynamic Single Draft Scale Using Intentionally Generated Signal Noise.

As noted above, the ideal waveform 40 of FIG. 2 shows that the weight on the scale 10 changes as a function of time. The waveform 40 has a substantially inverse symmetrical shape that consists of multiple distinct plateaus. It is expected that the weight signal will routinely contain some normal random noise that may be generated, for example, by the vibration of the vehicle or the vehicle driving over the rough surface of the weighing platform 14.

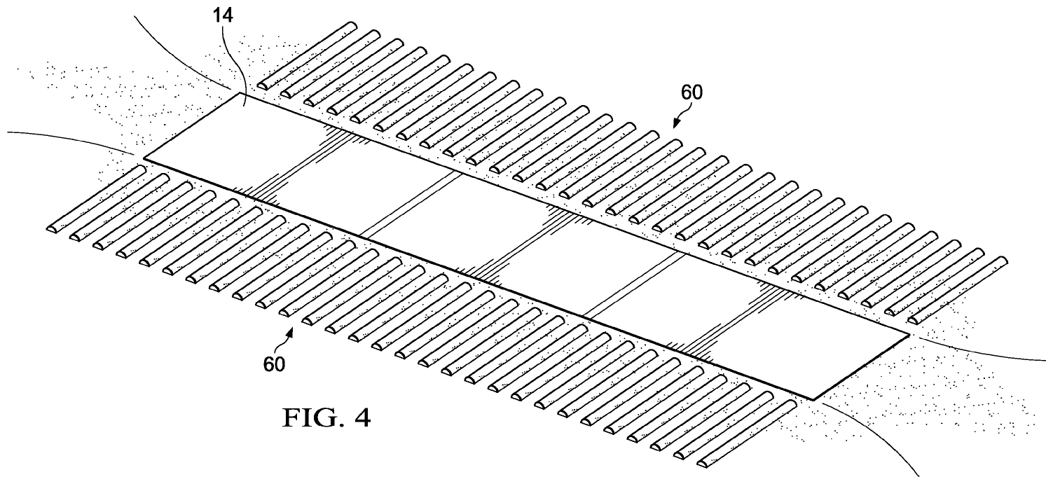

In another aspect of the inventive concept, illustrated schematically at FIG. 4, weight signal noise may also be intentionally generated by installing means 60 for generating weight signal noise that vibrate the vehicle as it drives over them. By positioning a weight signal noise generating means 60 adjacent to a weighing platform 14 that is installed at grade, the resulting weight signal noise generated can be used to monitor if the vehicle has driven off the weighing platform during the weighment. Also, the noise generated by these weight signal noise generating means 60 will only be shown on the waveform while the vehicle is moving. If the vehicle stops for a static weight, the noise will disappear, and then restart as the vehicle moves again. Some examples of weight signal noise generating means 60 include a rough gravel like surface, multiple raised bumps, multiple painted stripes, multiple grooves cut into the pavement, or any other such means intended to cause a vibration when driven over. By positioning the weight signal noise generating means 60 immediately adjacent to the weighing platform 14, signal noise would be generated even if a wheel was only partially off the weighing platform. Furthermore the weight signal noise generating means 60 should extend as far out from the weighing platform as is reasonable for the vehicle to drive off the scale before the mispositioning would become obvious to the scale operator.

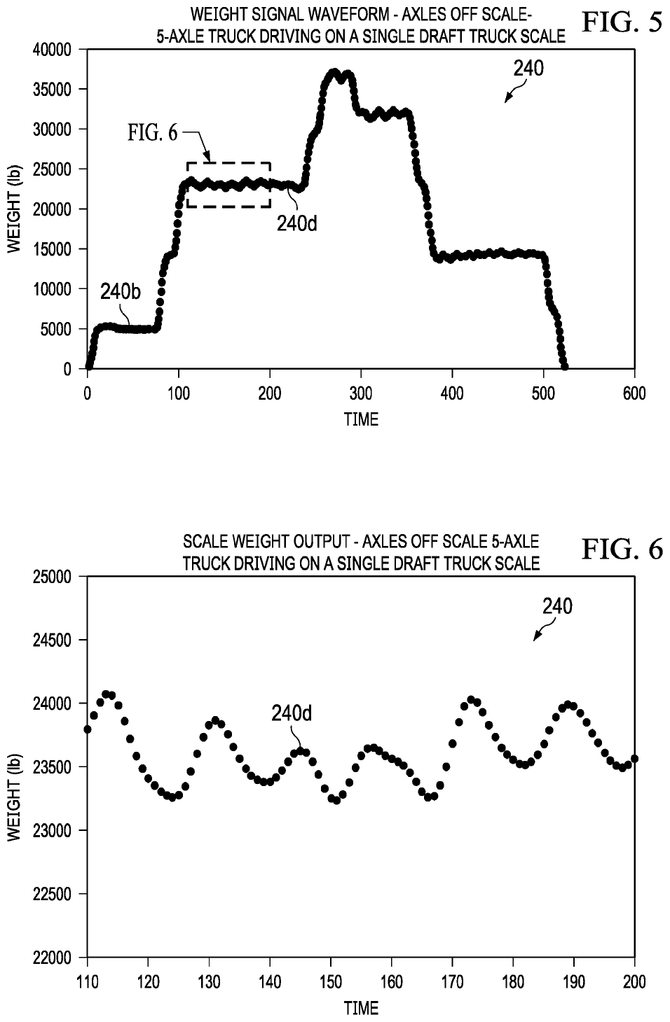

While the vehicle is on the weighing platform 14, a normal level of weight signal noise is created. If at least some wheel is partially displaced laterally off of the weighing platform 14, the magnitude of the weight signal noise increases as the vehicle drives over the weight signal noise generating means 60. Furthermore, if the noise generating means 60 is placed at a regular spaced interval (e.g. rumble strips), the weight signal noise generated becomes periodic rather than random. If a difference in the weight signal noise magnitude and/or frequency is detected, the driver will receive a notification and need to reweigh their vehicle to complete a weighment. FIG. 5 illustrates exemplary weight signal waveform 240 for a 5-axle vehicle with the vehicle on and off the weighing platform with a noise generating means 60 placed adjacent to the lateral side edges of the weighing platform 14 and spaced at a regular interval. The waveform 240 shows a generally flat first plateau 240b, in which the wheels of the steer axle bear solely on the scale. At this point the weight signal contains a normal level of weight signal noise. A second plateau 240d is formed as the steer and drive axles bear on the scale. This plateau 240d, unlike the first plateau 240b, contains a periodic noise characteristic that suggests at least some portion of steer and/or drive axles are at least partially off of the platform 14 and being driven over the noise generating means 60 that has been placed at a regular interval. FIG. 6 illustrates in more detail the weight signal noise being generated in the second plateau 240d of FIG. 5. Although a full weight signal waveform 240 is shown in FIG. 5, it is clear that a potential problem has arisen in the weighing process long before the full waveform is developed.

Other embodiments may contain weight signal noise generating means 60 that are not placed at a regular intervals. Increased random noise would also suggest at least some portion of the vehicle axles are at least partially off the platform 14.

In addition to the noise generated on the vehicle weight waveform 240, the signal noise-generating means 60 may also generate audible noise and a vibration felt by the driver. This provides a physical warning to the driver that the truck has driven off the weighing platform. This is particularly helpful to the driver when the weighing platform is covered by snow, for example, and it is difficult for the driver to ascertain where the lateral side edges of the weighing platform are located.

In both methods of detecting transverse vehicle mispositioning, it is desirable to use the memory and hardware processing system 36 to automatically determine the mispositioning, especially through the use of machine learning, or other algorithms, to train the processing system.

While all of the foregoing examples use a generic five-axle tractor-trailer as an example of a vehicle passing over a vehicle weigh scale, the extension of the concept to other types of multi-axle vehicles will be known to one of skill in the art.

While all the foregoing examples show the entire waveform from the vehicle first entering to completely exiting the scale for illustrative purposes, it will be known to one of skill in the art that only a sufficient portion of the waveform to determine mispositioning is required in practice.

The methods presented above for automatically detecting vehicle mispositioning on a vehicle scale are practical and effective. Although the methods are effective individually, their effectiveness can be increased by using multiple methods together. These methods do not require any additional sensors, barriers, curbs, bollards, or guard rails to be added to the vehicle scale. Only the weight signal from the scale is required. This minimizes cost and maximizes reliability. The scale is not subject to damage by vehicles running over them or becoming unreliable due to dirt accumulation and weather conditions. Unlike barriers, curbs, bollards, or guard rails, there is no risk of damage to vehicles.

1. A method for detecting an improper positioning of a vehicle on a weight scale, said method comprising the steps of:
providing a weight scale for weighing a multi-axle vehicle, the weight scale having a weighing platform, with a weighing area having a length and a width, for simultaneous placement of the plurality of axles on the weight platform;
sensing a portion of a weight of the multi-axle vehicle in at least one load cell upon which the weighing platform bears and transmitting an output signal from each load cell;
generating an at least partial vehicle weight waveform of vehicle weight as a function of time, based on the at least one load cell output signal; and
determining whether to reject a weighment of the vehicle, if the generated vehicle weight waveform indicates that at least some portion of the vehicle was improperly positioned outside the weighing area.

2. The method of claim 1, wherein the vehicle weight waveform is a static measurement generated by stopping the vehicle on the weighing platform.

3. The method of claim 1, wherein the vehicle weight waveform is a dynamic measurement generated by driving the vehicle across the weighing platform without stopping.

4. The method of claim 1, wherein the vehicle weight waveform generated has a first portion that increases monotonically as the vehicle enters the weighing platform and has a second portion that decreases in a symmetrically inverse manner as the vehicle exits the weighing platform, such that, in determining proper positioning, an unexpected decrease during the first portion or an unexpected increase during the second portion indicates an improper positioning of the vehicle on the weighing platform.

5. The method of claim 4, wherein the first portion of the vehicle weight waveform comprises a series of plateaus that correspond to the number of axles or axle groups in the multi-axle vehicle.

6. The method of claim 4, wherein an absence of inverse symmetry between the first and second portions of the vehicle weight waveform indicates improper positioning of the vehicle.

7. The method of claim 1, wherein the step of providing the weight scale further comprises providing means for generating weight signal noise on a surface laterally adjacent to the weighing platform.

8. The method of claim 7, wherein the weight signal noise generating means comprises raised bumps.

9. The method of claim 7, wherein the weight signal noise generating means comprises grooves cut into the lateral surface.

10. The method of claim 7, wherein the weight signal noise generating means are spaced at regular intervals.

11. The method of claim 7, wherein the presence of weight variations in any portion of the vehicle weight waveform plateaus indicates improper lateral positioning of the vehicle.

12. The method of claim 1, wherein the steps of generating and analyzing the vehicle weight waveform to determine if the vehicle is improperly positioned are conducted by an algorithm operable in the hardware processing system.

13. The method of claim 1, wherein the vehicle weight is determined from the vehicle weight waveform if the weighment is not rejected.

14. The method of claim 5, wherein an absence of inverse symmetry between the first and second portions of the vehicle weight waveform indicates improper positioning of the vehicle.

15. The method of claim 2, wherein the step of providing the weight scale further comprises providing means for generating weight signal noise on a surface laterally adjacent to the weighing platform.

16. The method of claim 3, wherein the step of providing the weight scale further comprises providing means for generating weight signal noise on a surface laterally adjacent to the weighing platform.

17. The method of claim 11, wherein the steps of generating and analyzing the vehicle weight waveform to determine if the vehicle is improperly positioned are conducted by an algorithm operable in the hardware processing system.
